(19) United States
(12) Patent Application Publication
(10) Pub. No.: US 2005/0212704 A1
(43) Pub. Date: Sep. 29, 2005

(54) Use of an inverted L-antenna in a motor vehicle

(75) Inventor: Pascal Hofmann, Ulm (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 11/076,524

(22) Filed: Mar. 9, 2005

(30) Foreign Application Priority Data
Mar. 10, 2004 (DE) 10 2004 011 970.8
Jun. 7, 2004 (DE) 10 2004 027 692.7

(51) Int. Cl. H01Q 1/38

(52) U.S. Cl. 343/700 MS; 343/711

(57) ABSTRACT

A method for providing an inverted-L antenna in motor vehicle includes providing a microstrip line and providing a laminar motor vehicle component including an electromagnetically transparent material, the laminar component forming part of an outer skin of the motor vehicle. The inverted-L antenna is disposed under the laminar motor vehicle component so as to be electromagnetically coupled to the microstrip line in a contactless manner.

Priority is claimed to German patent applications DE 10 2004 011 970.8, filed Mar. 10, 2004, and DE 10 2004 027 692.7, filed Jun. 7, 2004, the entire disclosures of both of which are hereby incorporated by reference herein.

The present invention relates to a motor vehicle having an inverted-L antenna.

JP-A-2001-189616 describes antennas embedded in multilayered glass panes where individual glass layers are used as a dielectric between the L-shaped and/or F-shaped part of the antenna and the microstrip line. In this manner, the L-shaped or F-shaped parts are electromagnetically coupled to the microstrip line in a contactless manner.

Inverted-L antennas are known, for example, from documents DE 198 80 497 T1, EP 856 907 A1 and EP 1 024 552 A2. Other literature references include: R. King et al., Transmission-line missile antennas, IRE Trans. Antennas Propagat., vol. 8, pp. 88-90, January 1960; R. J. F. Gürtler: Isotropic transmission-line antenna and its toroid-pattern modification, IEEE Trans. Antennas Propagat. vol. 25, pp. 386-392, May 1977; M. J. Ammann et al., A novel hybrid inverted-L-antenna with wide bandwidth, 12th IEE International Conference Antennas & Propagat. 2003, Vol (2) pp. 720-722; K. Kagoshima et al., Analysis of a planar inverted F-antenna fed by electromagnetic coupling, 1992 IEEE Int. Antennas Propagat. Symp. Di. vol. 30, pp. 1702-1705, July 1992; K. Virga und Y. Rahmat-Samii, An enhanced-bandwidth integrated dual L antenna for mobile communications systems—Design and measurement, 1995 IEEE Int. Antennas Propagat. Symp. Dig. Vol, 33, pp. 1120-1123, June 1995.

Moreover, in automotive applications, it is known to install externally mounted antennas on glass or plastic roofs of vehicles.

### SUMMARY OF THE INVENTION

An object of the present invention is to provide a method for providing an automotive antenna in a motor vehicle in an easy to install manner to give good reception characteristics.

According to the present invention an inverted-L antenna is installed in the area of a substantially two-dimensional, or laminar, motor vehicle component, which is made of an electromagnetically transparent material and forms part of the outer skin of the motor vehicle; the inverted-L antenna being located below this laminar component and being independent from said component in terms of production.

The electromagnetically transparent component may, for example, be a roof made of glass or plastic (optionally also a sliding roof), or a trunk lid made of plastic. The windows of the vehicle may also form the electromagnetically transparent component.

Because the laminar component forms part of the outer skin of the motor vehicle, and the antenna is integrated under the vehicle skin, a design advantage is obtained since no antenna part protrudes from the silhouette of the outer skin of the vehicle. Further advantages are obtained in terms of installation space and robustness of the antenna. This is especially true with regard to vandalism damage.

Since, in terms of production, the antenna is independent from this laminar component, manufacture is advantageously simplified. Therefore, unlike the prior art, the antenna does not need to be integrated already during the manufacture of the component in question. Because of this, the individual parts may advantageously be separately and independently manufactured and delivered to the vehicle assembly line.

The radiating element of the inventive antenna is an inverted-L antenna, as is known in principle from the literature. The inverted-L antenna can be considered as an angularly bent λ/4 monopole on a ground surface or, in its planar form which has a larger bandwidth, as a microstrip line antenna shortened by short-circuiting.

The inverted-L antenna belongs to the resonant antennas, and the wavelength of the fundamental mode in question here is then, analogous to the λ/4 monopole, about four times the total length of the L-shaped part. While the length determines the resonant frequency of the antenna, the height (of the bending point) and the width of L-shaped parts affect the bandwidth of the antenna. The bandwidth of the antenna increases with increasing width of the L-shaped part. In this connection, the width should be kept below the level where lateral resonances occur in the frequency bands in question. The directional diagram of the antenna corresponds approximately to that of a λ/4 monopole on a ground surface and to that of the widespread planar inverted-F antenna, which represents an extension of the L antenna. With increasing width of the planar antennas, the directional diagram loses its omnidirectional, monopole-like characteristic. Therefore, a compromise must be found between the bandwidth and the directional diagram.

The fact that inverted-L and inverted-F antennas have lower heights (angular bending, increased end capacitance) compared to the λ/4 monopole but a similar radiation pattern makes them suitable as radiating elements if, given a horizontal ground surface, the aim is to achieve a most omnidirectional, vertically polarized radiation and/or reception in an azimuthal plane, as is particularly required for mobile radio antennas in automotive applications.

In an embodiment, the height of the microstrip line is less than half the height of the L-shaped antenna.

Advantageously, it turns out that if the height of the coupled microstrip line is, for example, 0.3 to 0.5 times the antenna height, the radiation properties in the horizontal direction are at most only slightly affected.

In an embodiment, at least one further L antenna is laterally coupled to the microstrip line.

This embodiment has an advantage over another embodiment, namely the capacitive coupling in the form of a coaxially fed coupling plate with additional parallel load. In fact, in an embodiment of that type, further antennas cannot be easily coupled.

Thus, the inventive design allows easy implementation of reception possibilities in different frequency bands by coupling various L-shaped antennas to the microstrip line.

This coupling differs from multiband antennas, which are based on a plurality of radiation-coupled single-band antennas (frequently L or F antennas), or have complex geometries (folded, slotted, . . . ) having several resonances.

In an embodiment, the parts of the antenna are stamped and suitably shaped concurrently with the manufacture of the vehicle body.

This facilitates the manufacture of the antenna during the manufacturing process. Moreover, weight and space are saved by using vehicle components as the antenna.

In an embodiment, the microstrip line is bent down 90 degrees at its end, leaving a gap between the end of the vertical part of the microstrip line and the horizontal ground surface; the horizontal ground surface further having an additional vertical element, which is disposed at least substantially parallel to the vertical part of the microstrip line; and the inner conductor of the coaxial cable being contacted with the microstrip line; and the outer conductor of the coaxial cable being contacted at the additional vertical element.

This embodiment has the advantage of a reduction and partial compensation of the inductive component, which results in good adaptation and low insertion loss over a wide band. Due to the vertical ground surface, the gap to be bridged by the inductively acting inner conductor can be kept small. Moreover, the inductive effect of the inner conductor is partially compensated by the capacitive effect of the two parallel metal surfaces of the vertical microstrip line and the ground surface.

In an embodiment, the laminar component is made of glass or plastic, and is used as an antenna radome.

Due to electrical permittivity, a shortening of the resonant antenna elements is obtained, which needs to be taken into account when designing the antennas.

In an embodiment, the horizontal elements of the L antenna are in direct contact with the inner side of the laminar component made of glass or plastic.

Because of the electrically permittivity of the glass or plastic, the radiating elements of the antenna can therefore be maximally shortened.

In an embodiment, the horizontal elements of the L antenna have a certain distance from the laminar component.

This embodiment provides a greater independence with respect to tolerances, which may result from the thickness or the permittivity of the glass. Advantageously, the certain distance is kept small.

In an embodiment, the L antenna is arranged at the front end of the microstrip line in such a manner that it is laterally offset therefrom.

This lateral offset, in conjunction with the gap distance of the open end of the microstrip line from the vertical part of the L antenna, makes it possible to adapt the coupling.

In an embodiment, at least one further L antenna is disposed laterally of the microstrip line.

Advantageously, this provides a simple way to implement a multiband antenna by using different resonant frequencies.

### BRIEF DESCRIPTION OF THE DRAWINGS

FIG. 1 shows the contactless, capacitive coupling of an L-shaped antenna structure to the microstrip line.

FIG. 2 is a side view of an L-shaped antenna structure and a microstrip line under a dielectric cover plate.

FIG. 3 shows the coupling of further antennas to the microstrip line.

FIG. 4 shows the contacting of a coaxial cable.

### DETAILED DESCRIPTION

Unlike some other inverted-L antennas described, the antenna element in question is not fed coaxially at its base or at a higher point, but is electromagnetically (capacitively) coupled to a microstrip line 2 in a contactless manner, as shown in FIG. 1. Unlike coaxial feeding, L-shaped antenna structure 1 is here conductively connected to ground surface 3 without any gap. This simplifies the design considerably.

This type of feed is already known as one of the standard coupling options for microstrip line antennas.

Here, the height of coupling microstrip line 2 is significantly smaller than that of L-shaped radiating element 1, for example, 0.3 times to 0.5 times the antenna height in order to affect the radiation properties in the horizontal direction as little as possible.

The line impedance of microstrip line 2 can be selected relatively freely; a 50-Ω feedline providing a solution for connection to, for example, a 50-Ω coaxial system.

A loose linkage of the field to microstrip line 2 due to a low-permittivity dielectric increases the strength of the coupling of line 2 and antenna element 1. A low-loss dielectric makes it possible to reduce the dielectric losses in microstrip line 2. Air as an ideal dielectric with regard to both requirements, which may be approximately implemented, for example, using rigid foam or low-loss, low-permittivity supports or spacers along line 2.

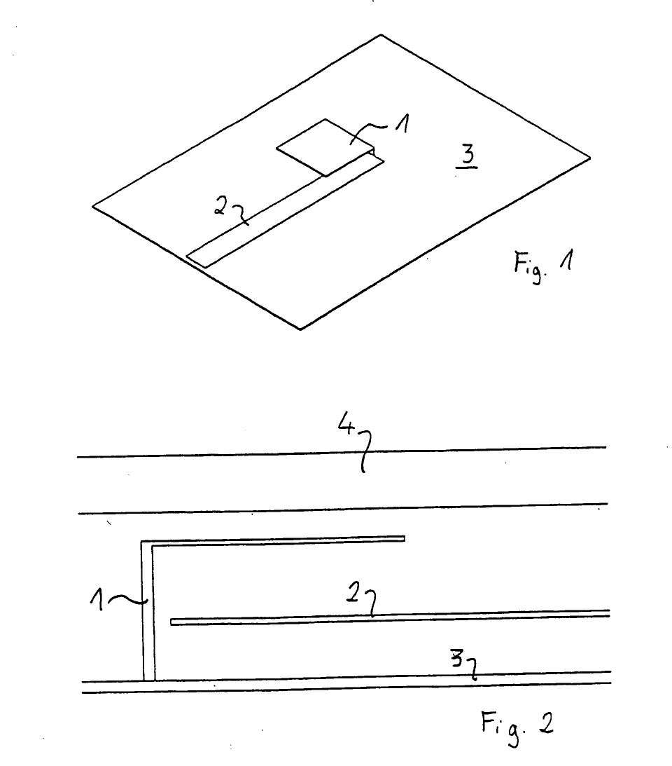

The coupling of L antenna 1 can be accomplished either at the open front end of a microstrip line 2 or laterally therefrom. Coupling at the front end is advantageous for a coupled antenna 1 and/or the first element 1 of a multiband antenna system. In this connection, the open end of microstrip line 2 forms a narrow gap with the vertical part of L antenna 1, as can be seen in FIG. 2. The adaptation may be optimized via the gap width and the lateral offset of L antenna 1 from line 2. Given appropriate mechanical properties and attachment of the base edge to ground surface 3, radiating element 1—the L antenna—makes do without a dielectric or mechanical supports. The use of dielectrics or ferrites advantageously allows L-shaped part 1 to be reduced in size. If the case of installation under a glass or plastic roof or a plastic rear lid 4, the anyway exiting dielectric layer (glass or plastic) above L antenna 1, which is shown in FIG. 2 by reference numeral 4, can be used as a radome and a dielectric shortening the length of the antenna. In this connection, the dielectric layer forms only a part of the covering of antenna 1 and, in particular, is not located between L-shaped part 1 and microstrip line 2.

L antenna 1, which is electromagnetically coupled via microstrip line 2, has the particular advantage that it allows further L antennas 5 to be coupled as resonant radiating elements to a microstrip line 2 in a contactless manner with little effort. If these elements 5 have different resonant frequencies, it is possible to produce multiband antennas in this simple manner.

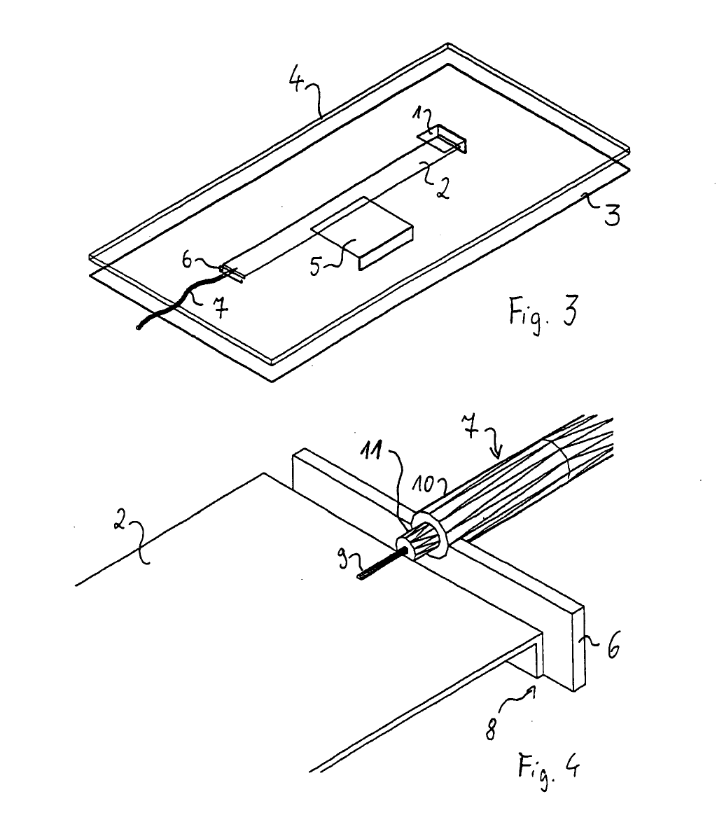

In that case, first L antenna 1 is coupled at the front end as described above, while further antennas 5 are coupled laterally of microstrip line 2, as illustrated in FIG. 3. FIG. 3 shows only one further antenna 5 for a lower frequency band, but it is also possible to install several other antennas 5.

Good coupling of antenna 5 is accomplished by positioning lateral antennas 5 in such a manner that the open end of L antenna 5, at which the electrical field is maximum, is located approximately above the edge of microstrip line 2 at the position of an electric field maximum (at the resonant frequency of the laterally coupled antenna) on microstrip line 2. The electric field maximum at the end of line 2 feeds front-end antenna 1; the second maximum can then be used for lateral antennas 5.

Therefore, an advantageous distance for L antennas 1, 5 is about one-half of the line wavelength from the end of line 2. If this distance is to be reduced, it is possible to shorten the line wavelength and, thus, the minimum distance using a line dielectric in the area between the two antennas 1, 5.

The standing waves in line 2, which generate the desired field maxima in the frequency bands of lateral antennas 5, occur outside the frequency band of front-end antenna 1 as a result of reflections at this antenna (mismatch).

Further antennas 5 may be coupled at both sides of microstrip line 2, so that no space conflict between adjacent frequency bands occurs. Due to the spacing of the individual antennas 5, the antenna elements shadow each other only to a relatively small degree so that a nearly omnidirectional radiation pattern is maintained. The laminar, low design of this antenna system makes it particularly suitable for externally invisible integration under motor vehicle roofs or rear lids 4 made of glass or plastic.

FIG. 3 shows such an antenna system. The electrically transparent glass or plastic 4 can advantageously be used here as an antenna radome and, due to its electrical permittivity, results in a shortening of the resonant antenna elements, which, however, needs to be taken into account when designing the antennas.

In this connection, the horizontal elements of L antennas 1, 5 may be in direct contact with the inner side of glass or plastic 4, or be slightly spaced therefrom. The advantage of the first case is that radiating elements 1, 5 are maximally shortened due to the electrical permittivity of the glass or plastic, whereas in the second case (side view as shown in FIG. 2), the spacing provides less sensitivity to tolerances, which may concern the thickness and permittivity of glass/plastic 4, and variations in the thickness of the space between antenna 1, 5 and glass/plastic 4.

Furthermore, inverted-L antennas 1, 5 and vertical element 6 of ground surface 3 may advantageously be formed as sheet-metal components of, for example, the roof frame, in which case horizontal ground surface 3 is formed by the roof frame. The parts may be produced, for example, by a forming and stamping process, and be provided on the roof frame during the roof assembly. Thus, parts of the antenna are formed by the vehicle body.

Then, in a final step, microstrip line 2 must be inserted, for example, with the inner conductor of coaxial cable 7 pre-mounted, and the outer conductor of coaxial cable 7 must be connected to vertical ground surface 6.

This use of original and/or modified dielectric and metal vehicle components as functional elements of the antenna reduces weight and saves manufacturing and assembly costs.

The transition from coaxial cable 7, which is usually used to connect antennas, to feeding microstrip line 2 may be implemented in many ways. A variant which is particularly advantageous for this structure is shown in FIG. 4:

The end of microstrip line 2 is bent down 90 degrees at its end, leaving a gap 8 between the end of the vertical part of microstrip line 2 and the horizontal ground surface (not shown here).

The horizontal ground surface has an additional vertical element 6, which is disposed parallel to and slightly spaced from the vertical part of microstrip line 2. In an advantageous embodiment, the height and width of this vertical element 6 advantageously correspond to the height and width of microstrip line 2.

Microstrip line 2 is centrally contacted as shown by inner conductor 9 of the coaxial cable in the area behind the bending edge in the horizontal portion of microstrip line 2.

Outer conductor (shield) 10 of coaxial cable 7 contacts the ground surface at additional vertical element 6 of the ground surface. This vertical element 6 is advantageously provided with a seat for coaxial cable 7.

In the region of the gap between additional vertical element 6 and the vertical part of microstrip line 2, coaxial dielectric 11 may be retained or removed.

This embodiment has the advantage of a reduction and partial compensation of the inductive component, which results in good adaptation and low insertion loss over a wide band. Due to vertical ground surface 6, the gap to be bridged by inductively acting inner conductor 9 can be kept small. Moreover, the inductive effect of inner conductor 9 is partially compensated by the capacitive effect of the two parallel metal surfaces of vertical microstrip line 2 and ground surface 6.

In the particular practical case of a 50-Ω system using air (spacers made of rigid foam) as a dielectric, the resulting geometry is as follows: height of microstrip line 2 above the horizontal ground surface: 5 mm, width of microstrip line 2: 23 mm, gap width between the vertical part of microstrip line 2 and vertical ground surface 6: 2 mm, gap width between the end of the vertical part of microstrip line 2 and the horizontal ground surface: 2 mm. Of course, microstrip line 2 may also be implemented on other low-loss substrates suitable for high-frequency applications.

1. A method for providing an inverted-L antenna in motor vehicle, the method comprising:
providing a microstrip line;
providing a laminar motor vehicle component including an electromagnetically transparent material and forming part of an outer skin of the motor vehicle; and
disposing the inverted-L antenna under the laminar motor vehicle component so as to be electromagnetically coupled to the microstrip line in a contactless manner.

2. The method as recited in claim 1 further comprising producing the inverted-L antenna independently from the laminar motor vehicle component.

3. The method as recited in claim 1 wherein a height of the microstrip line is less than half a height of the L-shaped antenna.

4. The method as recited in claim 1 further comprising laterally coupling at least one further L antenna to the microstrip line.

5. The method as recited in claim 1 further comprising stamping and suitably shaping at least one part of the inverted-L antenna concurrently with manufacture of a body of the vehicle.

6. The method as recited in claim 1 wherein:
the microstrip line includes an end portion bent down 90 degrees so as to form a vertical portion;
and further comprising:
providing a horizontal ground surface including a vertical element;
providing a coaxial cable having an inner conductor contacted with the microstrip line and an outer conductor contacted with the vertical element;
disposing the microstrip line so as to form a gap between an end of the vertical end portion and the horizontal ground surface; and
disposing the horizontal ground surface so that the vertical element is substantially parallel to the vertical end portion.

7. The method as recited in claim 1 wherein the laminar component includes at least one of glass and plastic and is configured to be used as an antenna radome.

8. The method as recited in claim 1 wherein the inverted-L antenna includes a horizontal element and further comprising disposing the horizontal element in direct contact with an inner side of the laminar component.

9. The method as recited in claim 8 wherein the laminar component includes at least one of glass and plastic.

10. The method as recited in claim 1 the inverted-L antenna includes a horizontal element and further comprising disposing the horizontal element at a distance from the laminar component.

11. The method as recited in claim 1 further comprising disposing the inverted-L antenna at a front end of the microstrip line laterally offset from the microstrip line.

12. The method as recited in claim 1 further comprising disposing at least one further L antenna laterally from the microstrip line.
